(19) United States
(12) Patent Application Publication
(10) Pub. No.: US 2026/0236972 A1
(43) Pub. Date: Aug. 13, 2026

(54) REAL-TIME RATE FILTERING SYSTEM FOR TRAVEL OFFER VALIDATION

(71) Applicant: HRS GmbH, Cologne (DE)

(72) Inventors: Tobias Ragge, Cologne (DE); Martin Biermann, Berlin (DE)

(21) Appl. No.: 19/312,037

(22) Filed: Aug. 27, 2025

Related U.S. Application Data
(63) Continuation-in-part of application No. 19/048,678, filed on Feb. 7, 2025, now abandoned.
Application No. 19/048,678 is a continuation of application No. 16/520,722, filed on Jul. 24, 2019, now abandoned.
(60) Provisional application No. 62/713,398, filed on Aug. 1, 2018.
(60) Provisional application No. 62/714,328, filed on Aug. 3, 2018.

(51) Int. Cl. G06Q 30/0601

(52) U.S. Cl. CPC G06Q 30/06291; G06Q 30/0641

(57) ABSTRACT

A system and machine-implemented method query offers from multiple supplier systems and filter inaccurate negotiated rates in reservation systems in real-time. A user makes a request to an offer search and booking system for travel products. The system then queries multiple supplier systems for available rates for the given search parameters provided by the user. Available offers are responded. A determination is made if two available offers represent the same offer. In case an offer duplicates another one, it is filtered out from the response. Another determination is made if an available offer is based on prior negotiations with the supplier. In case that a supplied negotiated rate does not match the contractually agreed attributes, it is filtered out from the response and prohibited from being consumed.

### CROSS-REFERENCE TO RELATED APPLICATIONS

This application is a continuation in part of U.S. patent application Ser. No. 19/048,678 filed Feb. 7, 2025, which is a continuation of U.S. patent application Ser. No. 16/520,722, filed Jul. 24, 2019, which claims the benefit of priority under 35 USC 119(e) of U.S. Provisional Application No. 62/713,398, filed on Aug. 1, 2018, and U.S. provisional application No. 62/714,328, filed on Aug. 3, 2018. All of which are incorporated by reference in their entireties.

### FIELD OF INVENTION

The present disclosure generally relates to travel distribution systems and travel reservation systems, in particular an integrated real-time rate multi-sourcing and rate filtering system.

### BACKGROUND

Travel distribution and reservation systems play a crucial role in the modern travel industry, facilitating the booking of accommodations, transportation, and other travel-related services. These systems connect travelers with a wide array of suppliers, including hotels, airlines, car rental companies, and other service providers. As the travel industry has evolved, so too have the complexities of managing and distributing travel offers.

One of the challenges in travel distribution is the negotiation of special rates between large organizations and travel suppliers. Many corporations, government agencies, and other entities negotiate preferential rates with hotels, airlines, and other travel providers for their employees or members. These negotiated rates often come with specific terms and conditions, such as pricing structures, cancellation policies, and included amenities.

The process of ensuring that negotiated rates are accurately reflected in travel offers presented to users can be complex. Travel suppliers must make these negotiated rates available through various distribution channels, including global distribution systems (GDS), online travel agencies (OTAs), and direct booking platforms. However, discrepancies can arise between the negotiated terms and the actual offers presented to travelers.

Another challenge in travel distribution is the proliferation of data sources and formats. Different suppliers may use varying methods to encode and transmit offer information, leading to potential inconsistencies or difficulties in comparing offers across multiple sources. This diversity of data formats can make it challenging to present travelers with accurate, up-to-date, and comparable travel options.

As discussed herein, rates may refer to one or more travel products, related additional services or amenities, and a negotiated price, price span, discount, or voucher. Travel products can be for example a hotel accommodation, a private or peer-to-peer accommodation in the sharing economy, an airline ticket, a car rental, a meeting room with or without meeting equipment, meals, activities, tours, ride shares, or other travel segments.

Rates are made available to travelers in the form of offers (in the following ‘offers’). An offer is comprised of a rate, a reservation period, period of validity, and eventually further information, for example customer eligibility to use the offer or allowed payment forms to pay for the offered contents.

An offered price can be further detailed in attributes of net values, taxes, fees, and gross values.

Offers are provided by a supplier through distribution systems for travelers to book them when planning a travel. Offers based on negotiated rates (in the following ‘negotiated offer’) can be made identifiable as such by a label or agreed identifier, for example, a rate access code.

Travel suppliers (in the following ‘suppliers’) can be direct producers, or intermediary resellers, or other kinds of distributors of travel products.

Some corporations, governments, non-government organization, associations, travel management companies, and online travel agencies (in the following ‘consumer’) negotiate rates with travel suppliers for the travelers in an organization, its subsidiaries or related organizations, and travelers. The outcome of the negotiations are negotiated rates. In some aspects negotiated rates are corporate rates, dynamic rates, chain discounts, chain-wide discounts, or any other form of a rate which attributes have been negotiated between the consumer and supplier.

Negotiated offers are considered correct, when their attributes match those of the underlying negotiated rates contractually agreed upon. Negotiated offers are incorrect, if any of their attributes does not match those of the underlying negotiated rates contractually agreed and therefore contain another, non-negotiated rate.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The disclosed subject matter relates to a machine-implemented method for retrieving offers from multiple supplier systems, de-duplicating multiple offers representing a same rate, and validating negotiated offers and classifying them in real-time to be correct or incorrect. In case a negotiated offer is incorrect, the method filters the offer and thereby prohibits the offer from being further distributed or bookable in a reservation system.

The disclosed subject matter further relates to a system for searching rate offers and making reservations for offers in an online booking tool or back office tool of a travel manager (hence referred to as ‘OBT’). An OBT provides a booking channel for a traveler to select offers for a travel and make a reservation for it in some connected reservation system (in the following ‘booking’). In some aspects, an OBT offers a search input form to take important information for the assumed travel, such as time of travel, origin and destination, number of persons traveling, and further detailed attributes of the travel supporting the determination of offers to be provided by suppliers as a result to the search. The person searching for offers in an OBT and eventually making a reservation through such OBT is in the following referred to as a ‘booker.’ Modern approaches to OBTs facilitate chat communication, voice activation mechanisms to fill those criteria of the search, or reservation automation systems making a booking on behalf of a booker.

The disclosed subject matter also relates to a system of one or more distribution systems that, eventually daisy-chained, are connected to an OBT providing offers for a specific search. Distribution systems can be global distribution systems (GDS), chain reservation systems (also computer reservation system, CRS), channel management systems (also ‘channel managers’), meta-search engines, or any other remote system providing a supplier the ability to distribute its offers into OBTs.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF FIGURES

Features of the subject technology are set forth in the appended claims. However, for purpose of explanation, several embodiments of the subject technology are set forth in the following figures.

FIG. 1 illustrates a block diagram of an exemplary system for real-time rate multi-sourcing and filtering, according to aspects of the present disclosure.

FIG. 2 illustrates a flowchart of an exemplary method for real-time rate multi-sourcing and filtering, according to an embodiment.

FIG. 3 illustrates a flowchart of an exemplary process for real-time rate multi-sourcing and filtering, according to aspects of the present disclosure.

FIG. 4 illustrates a flowchart of an exemplary process for real-time rate filtering, according to an embodiment.

FIG. 5 illustrates another flowchart of an exemplary process for real-time rate filtering, according to an embodiment.

FIGS. 6A-6B illustrate an example interactive interface providing search results and offer management, according to an embodiment.

FIGS. 7A-7D illustrate an example interactive user interfaces providing graphical representations, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As mentioned above, some organizations negotiate travel products with suppliers. The outcome of the negotiations are negotiated rates. Upon finishing the negotiation, the supplier has to make available the negotiated rates in the form of offers as per the agreed terms for booking through its distribution systems so that a booker can search for them, select them when returned, and book them in OBTs connected to the distribution systems.

The problem with this method is that the supplier may miss to provide negotiated rate attributes in the offers completely or provide attributes differently than they were agreed upon, when loading them into the distribution channels, or some involved system may manipulate the attributes. As a result, the booker may be provided with some negotiated offer which attributes may not comply with the negotiated terms. This may mean a deviation of the offer's price from the agreed value of the anticipated negotiated rate price. Hence the booker must be provided a method to identify incorrect negotiated offers and filter them from being bookable by the booker.

The subject technology provides for protecting the bookers from booking incorrect negotiated offers. A booker uses an OBT and searches for a travel product. When starting the search, the OBT forwards the request to a distribution system or sends a secondary request to that respectively. The content provider connects to a distribution system, and requests available offers as provided by suppliers. Those offers can be negotiated offers. Upon collecting adequate offers for the request, the distribution system first forwards the results to a real-time rate filtering system which analyzes each offer's attributes. In case the offer is a negotiated one, the real-time rate filtering system validates its attributes with corresponding negotiated rate contract data. If no contract data can be found or any attribute of the offer is missing or deviates from the attributes in the corresponding negotiated rate contract data, the real-time rate filtering system excludes the offer from the result list then being sent to the OBT for the booker to select offers from and eventually book them.

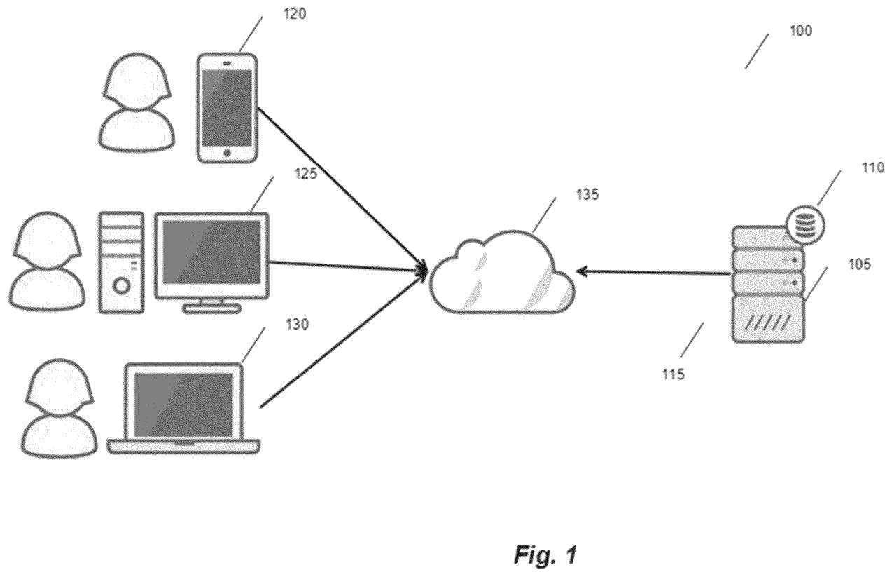

FIG. 1 illustrates an example network environment which can provide for real-time rate multi-sourcing and filtering. A network environment 100 contains computing devices 120, 125 and 130, and a computing system 115. Computing devices 120-130 and computing system 115 can communicate with each other through a network 135. Computing system 115 can include one or more computing devices 105 (e.g., one or more servers), respectively, and one or more computer-readable storage devices 110 (e.g., one or more databases), respectively.

Each of the computing devices 120-130 can represent various forms of processing devices. Example processing devices include a desktop computer, a laptop computer, a handheld computer, a personal digital assistant (PDA), a cellular phone, a smartphone, a tablet computer, or a combination of any of these data processing devices, or other data processing devices.

Computing device 115 may be systems or devices having a processor, a memory, and communications capability for providing content to the electronic devices. In some example aspects, server 115 can be single computing devices, for example, a computer server. In other embodiments, server 115 can represent more than one computing device working together to perform the actions of a server computer (e.g., cloud computing). Further, computing devices 105 can represent various forms of servers including, but not limited to a web server, an application server, a proxy server, a network server, or a server farm.

In some aspects, the network environment 100 can be a distributed client/server system that may span one or more networks, for example, network 135. Network 135 can be a computer network, for example, a local area network (LAN), wide area network (WAN), the Internet, a cellular network, a Wi-Fi network, or a combination thereof connecting any number of mobile clients, fixed clients, and servers. Further, the network 135 can include, but is not limited to, any one or more of the following network topologies, including a bus network, a star network, a ring network, a mesh network, a star-bus network, tree or hierarchical network, and the like. In some aspects, communication between each client (e.g., computing devices 120-130), and server (e.g., server 115) can occur via a virtual private network (VPN), Secure Shell (SSH) tunnel, or other secure network connection. In some aspects, network 135 may further include a corporate network (e.g., intranet) and one or more wireless access points.

In some examples, aspects any of the computing devices 120-130 transmits a request for offers to server 115 and server 115 receives the request. Server 115 obtains available offers for the request. Server 115 compares offers retrieved to be duplicated. Server 115 accesses a database of negotiated rate contract data to validate the retrieved offers against.

In case server 115 identifies some offers to be duplicated, server 115 removes duplicate offers from the list of obtained offers.

In case server 115 identifies some offers to be negotiated offers but incorrect, server 115 removes those offers from the list of obtained offers, before server 115 returns the list of retrieved offers to the computing device (e.g., any of 120-130).

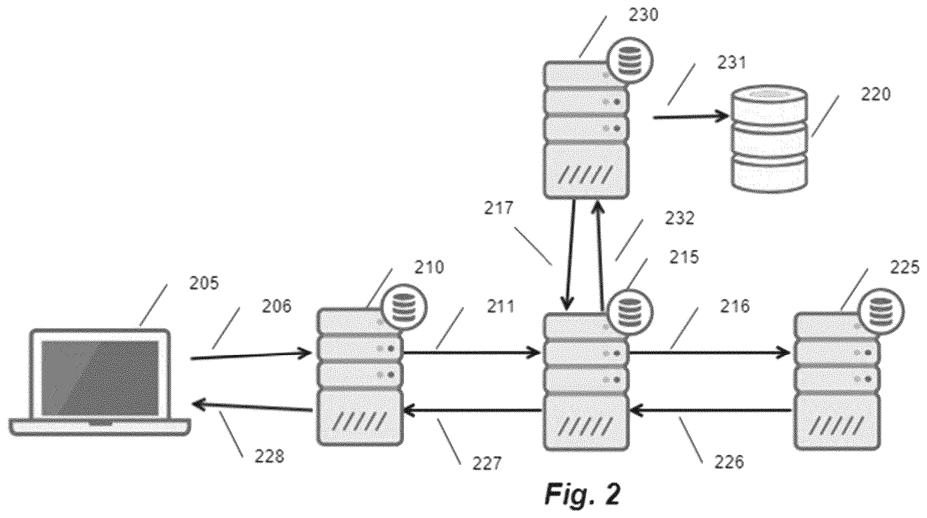

FIG. 2 illustrates an example of a client-server communication featuring real-time rate filtering. In the example, communication between a computing device 205 (e.g., any of computing devices 120-130), and a server 210 (e.g., server 115) over a network (e.g., network 135) is illustrated. In the example, server 210 further communicates over a network (e.g., network 135) with another computing system 215, which also communicates over a network (e.g., network 135) with another computing system 225. Computing system 215 communicates over a network (e.g., network 135) with another computing system 230, which communicates over a network (e.g., network 135) with a database system.

A software application or a web browser running on computing device 205 transmits a search request 206 for offers to computing system 210. In some aspects, computing system 210 can represent an OBT server to the OBT software application running or website running on computing device 205. Computing system 210 receives the request 206 and in consequence transmits another search request 211 to computing system 215. In some aspects, computing system 215 can represent a travel products aggregator system. Computing system 215 receives the search request 211 and in consequence transmits another search request 216 to computing system 225. In some aspects, the computing system 225 can represent a distribution system, for example a global distribution system for travel products, an online travel agency system, or specifically a hotel reservation system.

Computing system 225 responds to the search request 216 with a list of offers 226 computing system 225 has obtained based on the attributes given with the search request 216.

In the example, computing system 215 (e.g. an online travel agency reservation system) receives response 226 containing available offers from the computing system 225 (e.g. a hotel chain reservation system). Computing system 215 forwards the list received from request 216 in request 232 to computing system 230, which represents a real-time rate multi-sourcing and rate filtering system. In some aspects, computing system 215 can further manipulate the list from the representation received in response 226 to request 232.

Computing system 230 receives request 232 and compares each offer in the list received in request 232 with each other.

In case a duplicate offer in request 232 is identified, computing system 230 excludes it from the list from request 232.

Computation system 230 receives request 232 and loads negotiated rate contract data with request 231 from negotiated rate contracts database 220. Computing system 230 analyzes the offers received with request 232 and validates each contained offer with negotiated rate contract data loaded with request 231.

In case some negotiated offer contained in request 232 is classified as incorrect, computing system 230 excludes it from the list from request 232. When computing system 230 has sufficiently validated the offers received in request 232, it transmits the list of non-filtered offers in response 217 back to computing system 215. Computing system 215 then returns the list received in response 217 to computing system 210, in some aspects representing an OBT server. In some aspects, computing system 230 can further manipulate the list from the representation received in request 232 to response 217, and computing system 215 can further manipulate the list from the representation received in response 217 to response 227.

Computing system 210 transmits the list of validated offers in response 228 to the software application or web browser running on computing device 205.

In some aspects, requests 206, 211, 216, 232, and responses 216, 226, 227, and 228 can be exchanged in synchronous or asynchronous request/response communication.

In some example (not shown), servers 210, 215, and 215 can be composed into one or more servers combining each of their individual capabilities. In some aspects can a software application or web browser running on computing device 205 or a computing system 215 contain a real-time rate multi-sourcing and rate filtering system 230 and negotiated rates database 220. In some aspects can an OBT server 210 contain a real-time rate multi-sourcing and rate filtering system 230. In some aspects can computing system 225 contain a real-time rate multi-sourcing and rate filtering system 230 and negotiated rates database 220. In some aspects another server (not shown) can contain an OBT server 210, a real-time rate multi-sourcing and rate filtering system 230 with negotiated rates database 220 and a distribution system 225.

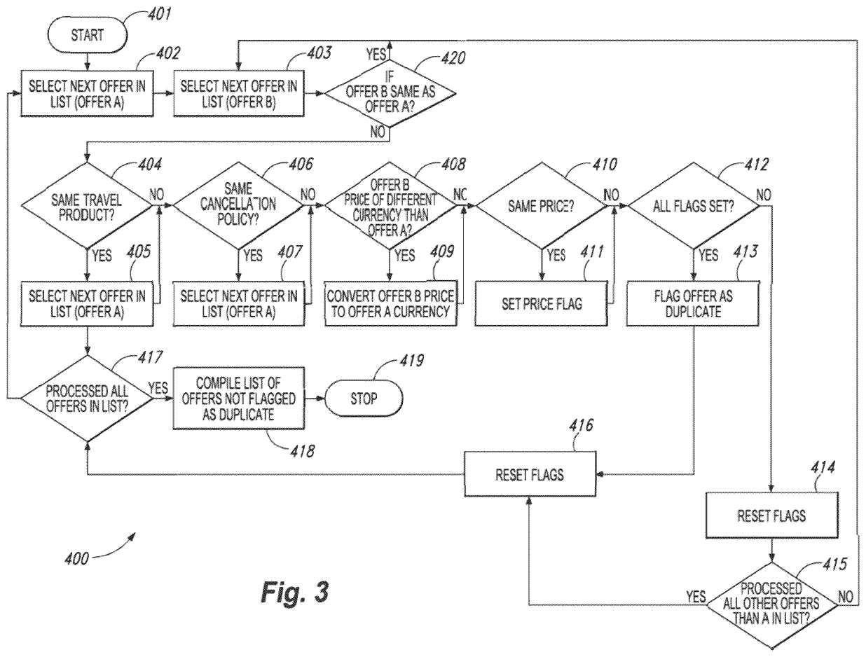

FIG. 3 illustrates an example process 400 by which real-time rate multi-sourcing is executed on computation system 230, eventually representing a real-time rate multi-sourcing system. In start block 401 the list of product offers in request 232 is received before iterated over in 402. For each iterated offer (hence referred to as “offer A”) in 402 the list of offers is iterated over again in a sub-routine in 403, so that each offer in the list is compared with each other throughout the process. Each offer in the sub-routine iteration in step 403 (hence referred to as “offer B”) is checked in step 420 whether it is the same as offer A. In case offer B is not the same as offer A in 420, the process progresses to step 404.

In case offer B is the same as offer A in 420, the next offer in the list is selected in 403.

In 404 it is checked whether offers A and B contain the same travel product and its contained properties, for example a superior hotel room category with included breakfast and parking. In case offers A and B contain different travel products as compared in 403, the process progresses to step 406.

In case both offers A and B contain the same travel product as compared in 403, a memory flag is set in 405, before progressing to step 406.

In 406 it is checked whether offer A contains the same cancellation policy as offer B. In case offer A contains a different cancellation policy as offer B in 406, the process progresses to step 408.

In case offer A contains the same cancellation policy as offer B in 406, a memory flag is set in 407, before progressing to step 408.

In 407 it is checked whether the price in offer B is of the same currency as the price in offer A. In case the currency of offer B is identical to the currency of offer A in 407, the process progresses to step 410.

In case the currency of offer B differs from the currency of offer A in 407, the price of offer B is converted into the currency of offer A in 409, before step 410 is triggered.

In 410 it is checked whether the price of offer B, or when converted in 409 the converted price of offer B, is the same as the price of offer A. In case the prices are not the same in 410, the process progresses to step 412.

In case the prices of offers A and B are the same in 410, a memory flag is set in 411, before progressing to step 412.

In step 412 it is checked whether all memory flags from 405, 407, and 411 are set. In case any flag is not set, the process progresses to step 414.

In case all flags from 405, 407 and 411 are set in 412, offer A is flagged as duplicate in 413, before progressing to step 416.

In 414 all memory flags from 405, 407, and 411 are reset, before progressing to step 415.

In 415 it is checked whether all offers in the list where iterated over in the sub-routine. In case not all offers where processed in the sub-routine, the process progresses to step 403.

In case all offers where processed in the sub-routine in 415, the process progresses to step 416.

In 416 all memory flags from 405, 407, and 411 are reset, before progressing to step 417.

In 417 it is checked whether all offers in the list where processed to determine whether they are considered a duplicate. In case not all offers from that list where processed, the process progresses to step 402.

In case all offers in the list of request 232 where processed in 417, the process progresses to step 418 in which the list all offers which were not labeled as duplicate in the process 400 are compiled into a list, before being returned in the stop block 419 to process 300. In some aspects, instead of compiling a new list of offers not labelled duplicate the process is set up in a way to remove those offers labelled duplicate from the list received in 401 before the list is returned in the stop block 419. In some aspects, the process is set up in a way to remove offers identified as duplicate in 412 from the list iterated over in 402 instead of labelling them in 413.

In some aspects, the steps in the process of real-time rate multi-sourcing in 400 are executed in different order or some of these steps may be skipped. In some aspects the steps in the process 400 may be amended by further steps of validation based on the offer's attributes available by the type of travel product. In some aspects the steps in the process 400 may be executed in parallel.

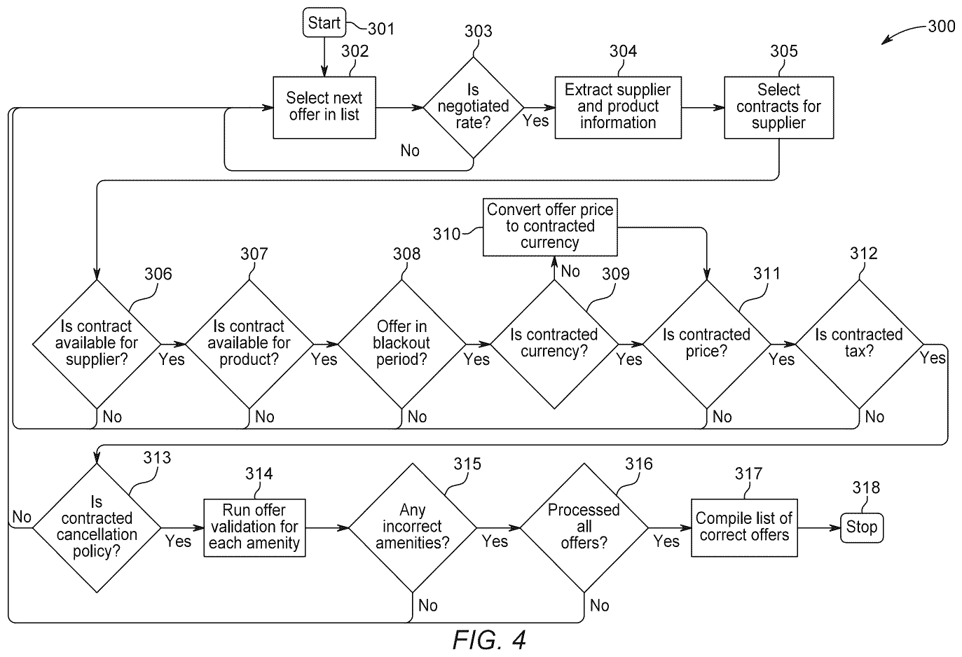

FIG. 4 illustrates an example process by which real-time rate filtering is executed on computation system 230, eventually representing a real-time rate filtering system. In start block 301 computation system 230 receives the list of product offers from process 400 in step 419, and iterates over each offer continuing in 302. The offer is checked to be a negotiated offer in 303. In case the offer is not a negotiated offer, the offer is classified correct and the next offer is loaded for validation in step 302.

In case the offer checked in 303 is a negotiated offer, the supplier identifier and product identification data is extracted from the offer in 304. In some aspects, product identification data can be a unique identifier or a tuple of identifying attributes, for example a hotel room category. Given the list of negotiated rate contract data retrieved in request 231, the corresponding contract data is chosen from the contract data list for the given supplier identifier and product identification data in 305.

In case no contract data was found for the given supplier identifier in 306, or some contract data was found for the given supplier identifier, but not for the given product identification data in 307, the offer is classified as an incorrect rate and the next offer is loaded for validation in step 302.

In case contract data was found for the given supplier identifier and product identification data in 306 and 307, the contract data is checked for agreed blackout periods which are validated against the offer's period in 308. In case the offer period falls into an agreed blackout period, the offer is classified as an incorrect rate and the next offer is loaded for validation in step 302.

In case there are no agreed blackout periods or the offer period doesn't fall into an agreed blackout period in 308, the offer's currency is validated against the agreed currency in the contract data in 309.

In case the offer's currency differs from the currency agreed in the contract data in 309, the offer's price is converted into the currency of the contract data in 310, before step 311 is triggered.

In case the offer's currency is the same as the currency agreed in the contract data in 309 or was converted in step 310, the resulting price of the offer is compared to the price in the contract data in 311. In case the offer's price was converted in 310, a tolerance can be applied to capture currency fluctuation. In case the offer price or converted offer price including the tolerance is not the same as agreed in the contract data in 311, the offer is classified as incorrect and the next offer is loaded for validation in step 302.

In case the offer's price or converted offer's price including the tolerance is the same as agreed in the contract data in 311, the offer's tax percentage is validated against the agreed tax in the contract data in 312. In case the offer's tax is not the same as agreed in the contract data, the offer is classified as an incorrect rate and the next offer is loaded for validation in step 302.

In case the offer's tax is the same as agreed in the contract data in 312, the offer's cancellation policy is validated against the agreed cancellation policy in the contract data in 313. In case the offer's cancellation policy is not the same as agreed in the contract data, the offer is classified as an incorrect rate and the next offer is loaded for validation in step 302.

In case the offer's cancellation policy is the same as agreed in the contract data in 313, the offer's amenities are extracted in 314 and are iterated as the actual offer starting in 302.

In case any of the offer's amenities is classified incorrect in 315, the offer is classified as an incorrect rate and the next offer is loaded for validation in step 302.

In case none of the offer's amenities is classified incorrect in 315, the offer is classified correct and it is checked whether there are further offers to be validated in 316. If there are further offers that are to be validated in the list, the next offer is loaded for validation in step 302.

In case there is no further offer in the list to be validated in 316, a list of all offers classified correct is compiled in 317, before being returned in the stop block 318 in response 217 transmitted from computation system 230 to computation system 215.

In some aspects, the steps in the process of real-time rate filtering in 300 are executed in different order or some of these steps may be skipped. In some aspects the steps in the process 300 may be amended by further steps of validation based on the offer's attributes available by the type of travel product the agreed attributes in the contract data. In some aspects the steps in the process 300 may be executed in parallel.

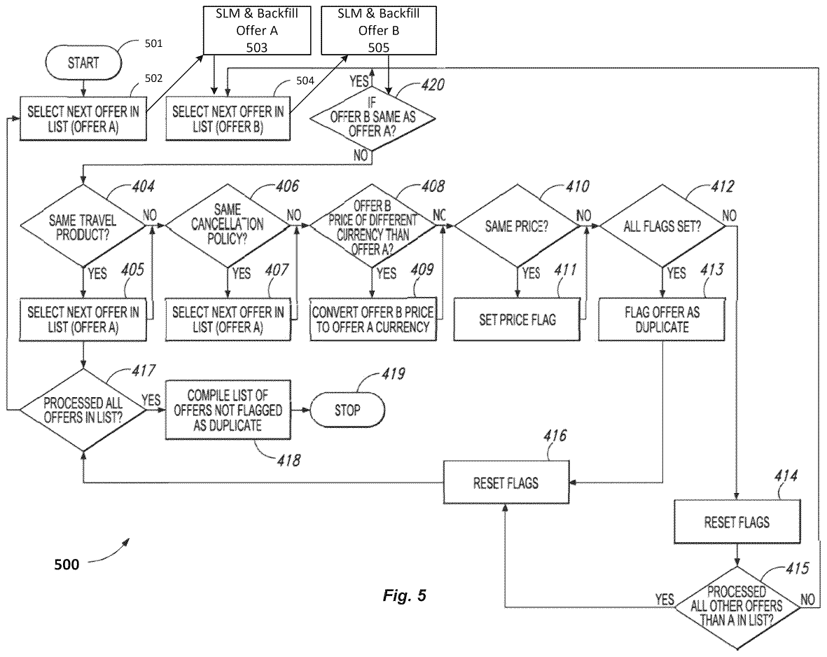

As shown in FIG. 5, an offer processing workflow 500 may start 501 and incorporate specialized language model (SLM) functionality after a selection of a next offer in a list (Offer A) 502, where the system determines whether to apply specialized language model processing, then performs SLM and Backfill Offer A 503. In examples, the SLM processing operations, i.e., 503 and 505 may extract rate attributes from unstructured offer data relating to its respective Offer A and Offer B, and perform probabilistic backfilling of missing information before continuing with the comparison and validation processes.

After SLM and Backfill Offer A 503 occurs, a selection of a next offer in the list (Offer B) 504 occurs. The process then proceeds to “SLM & Backfill Offer B” 505. The process the moves on to determining “If Offer B is the Same as Offer A?” 420, and the process continues similarly, as discussed with respect to FIG. 3.

The SLM may enable the system to handle diverse data formats from multiple supplier systems by normalizing unstructured rate information into a consistent format for attribute-based comparison. In some cases, the SLM may identify rate components that would otherwise be difficult to extract using conventional parsing methods, thereby improving the accuracy of offer de-duplication and contract validation processes. In some cases, the SLM may be trained specifically on historical travel offer data to process various proprietary data formats provided by different supplier systems. The SLM may extract structured rate components from unstructured text data that contains encoded travel product information.

The SLM may also process data from global distribution systems (GDS) and other supplier systems that provide offer information in proprietary coding and formatting methods. In some cases, unstructured source data may include text strings containing multiple rate attributes encoded within a single field, such as advance purchase requirements, loyalty point eligibility, room descriptions, accessibility features, bathroom amenities, connectivity options, physical room characteristics, occupancy limits, and meal inclusion status. The SLM may parse such unstructured text to identify and extract individual rate components for comparison against contract terms.

The rate filtering engine may also utilize probabilistic modeling techniques to infer additional offer attributes that are not explicitly mentioned in source datasets. This probabilistic modeling system may cross-match information from multiple data sources, including user reviews, hotel photos, and property data, to validate contract attributes and conditions against inferred rate components.

In some cases, the probabilistic modeling system may analyze textual content from user reviews to extract information about amenities, services, or features that may not be explicitly listed in the offer data. For example, the system may process review text mentioning “free breakfast” or “complimentary shuttle” to infer the presence of these amenities even if they are not directly specified in the rate information.

Property data from external sources may be incorporated into the probabilistic model to enhance attribute inference. This may include information such as hotel star ratings, nearby attractions, or historical pricing data. The system may use this supplementary data to estimate the likelihood of certain amenities or service levels being present, even when not explicitly stated in the offer.

When validating offers against contract terms, the probabilistic modeling system may assign confidence scores to inferred attributes. In some cases, these confidence scores may be used to determine whether an inferred attribute should be considered when assessing contract compliance. Attributes with high confidence scores may be treated as valid for comparison, while those with low confidence may be flagged for manual review.

The probabilistic modeling system may employ machine learning algorithms that continuously refine the inference model based on feedback and validation results. As more data is processed and outcomes are verified, the system may improve its ability to accurately infer missing offer attributes and validate them against contract terms.

In some cases, the system may use Bayesian inference techniques to update the probability estimates of certain attributes being present based on the observed data from multiple sources. This approach may allow the system to adapt to changing patterns in offer data and improve the accuracy of attribute inference over time.

The rate filtering engine may integrate the results of the probabilistic modeling into its validation process. When comparing offer attributes to contract data, the engine may consider both explicitly stated attributes and those inferred through probabilistic modeling. This comprehensive approach may enable more thorough contract compliance checking, especially in cases where source data may be incomplete or ambiguous.

As discussed herein, particularly with respect to FIGS. 3-5, offers may be programmatically associated with a structured set of memory flags. Memory flags may be binary indicators stored in memory that encode key attributes of the offer. These flags represent a compact, machine-readable abstraction of offer metadata, including but not limited to offer type, source system, eligibility criteria, client segmentation, and temporal validity. By encoding this information as discrete bits or bit fields, the system enables rapid access and evaluation of offer characteristics without requiring full object deserialization or complex data traversal.

During deduplication processes, systems and methods may perform a comparative analysis of memory flags across multiple offers. This comparison may be executed at the bit level, allowing the system to efficiently detect equivalence or near-equivalence between offers based on their encoded attributes. If two offers exhibit identical or functionally overlapping flag patterns, the system can infer redundancy and suppress one of the entries to prevent duplication. This approach not only accelerates the deduplication logic but also ensures deterministic behavior, which is critical for auditability and compliance in regulated environments.

Furthermore, the use of memory flags may support traceability. New attributes can be incorporated into the flag schema without disrupting existing logic, and each deduplication decision can be traced back to a specific flag comparison outcome. This design enables the system to maintain a high degree of transparency and explainability, which is particularly valuable in enterprise contexts where offer generation and selection must be both performant and defensible. The memory flag architecture may thus serves as a foundational mechanism for scalable, reliable, and auditable offer management.

The architecture supporting memory flags typically may further leverage bitwise operations for both assignment and evaluation, optimizing computational efficiency. When new offer data is ingested, attribute extraction modules transform relevant characteristics into a series of flag assignments, often using bit masking and shifting operations. These assignments may be stored in fixed-size integer or byte arrays, enabling high-speed batch processing and parallelized comparisons across large datasets. Such a representation reduces memory overhead and data access latency, making it particularly suitable for real-time or near-real-time rate filtering operations where performance is paramount.

Moreover, memory flag schemas may include bits or expandable flag segments that can accommodate future attributes or evolving business logic without necessitating schema migrations across the system. This modularity supports agile development and system resilience, as new flag types can be introduced through controlled feature toggles or configuration updates. The traceability of flag-based decisions further facilitates debugging, regression testing, and regulatory audits, as each offer's history and any deduplication or validation outcome can be reconstructed from the underlying flag state transitions.

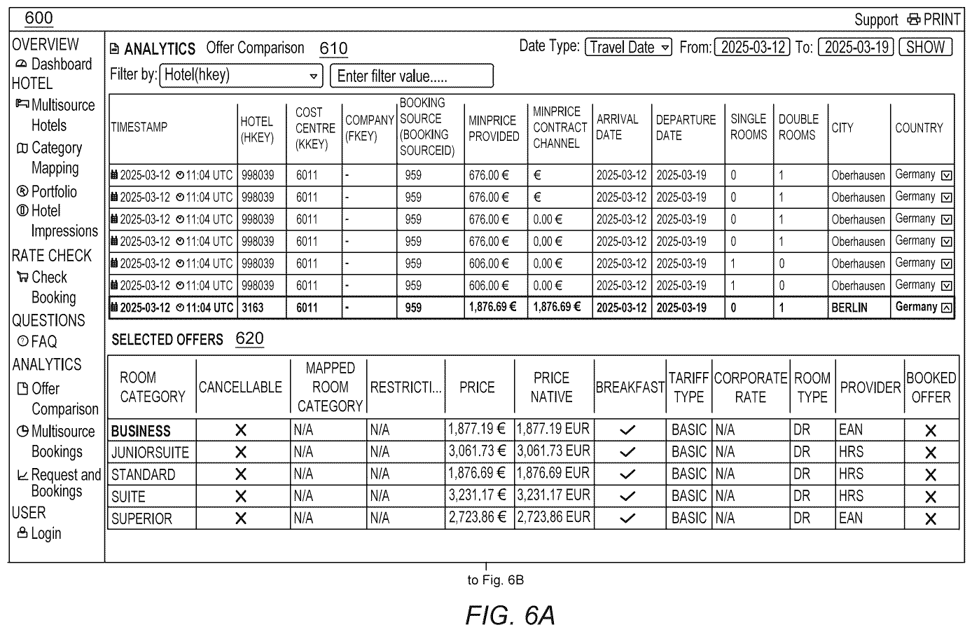

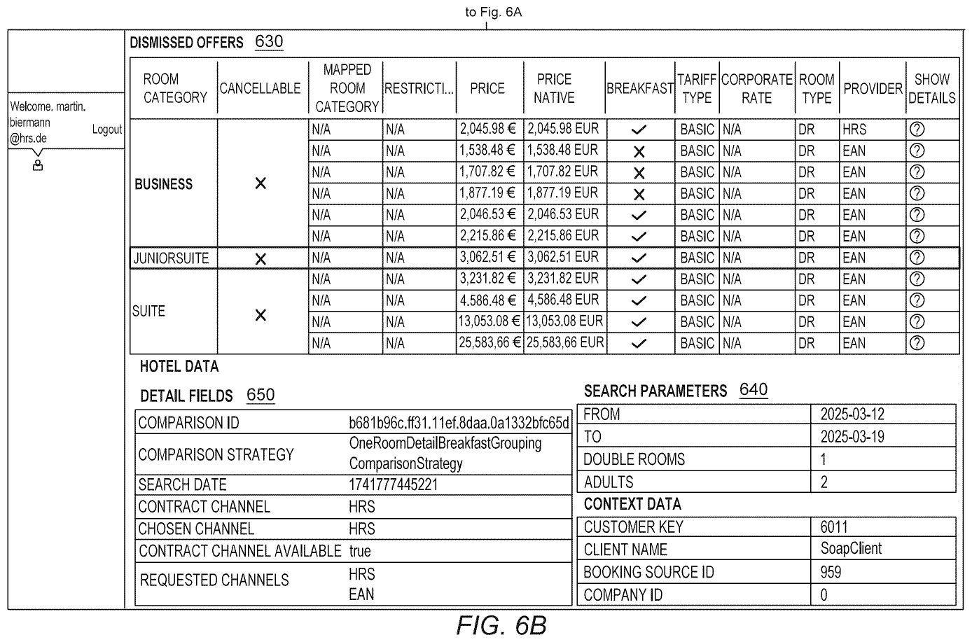

FIGS. 6A-6B illustrate an example interactive interface 600 that may be presented on a client computing device configured to transmit travel search parameters, results, and related information. The rate filtering system may thus provide an enhanced user interface with a harmonized information architecture for displaying and interacting with travel offers.

In examples, the interactive interface 600 may include a series of categorical selection buttons (e.g., on the left column or another portion of the interface) that upon selection will display in the main section of the screen, information related to the selection. The categorical selections may include, for example, an overall dashboard displaying all information, hotel information, such as multisource hotels, category mapping, portfolio, hotel impressions, rate check options, such as to check booking, frequently asked questions, and analytics, including but not limited to an offer comparison, multisource bookings, and requests and bookings. User information, such as login information can be provided upon selection as well. The selections to toggle between categories can include, on the interface, a button, tab, drop-down menu, text box, slider, or any of a plurality of user interface interactive items.

In the illustrated example, Offer Comparison 610 has been selected, which provides analytics information. The Offer Comparison 610 page may provide additional selections, such as one or more drop down menus, and/or a text box through which a user may specify the type of information they would like. If hotel key is selected, for example, a table of related information may be displayed, such as timestamp, hotel key, cost center, company, booking source, minimum price provided, minimum contract channel, arrival data, departure date, room type (single, double, suite, etc.), location (e.g., city, country, etc.).

The interactive interface 600 may also provide information related to selected offers 620, dismissed offers 630, search parameters, and hotel data 650. In the Selected Offers 620 and Dismissed Offers Category, a selection of one of the categories can provide additional information about the offer, such as room category, cancellation policy, mapped room category, restrictions, price, native price, breakfast, tariff type, corporate rate, room type, provider, and booked offer, among others.

The search parameters 640 may show information related to the hotel such as start date (from), end date (to), room type (e.g., double rooms), and number of travelers), as well as context data, such as customer key, client name, booking source id, and company ID.

The hotel data 650 can provide detailed information related to comparison ID, comparison strategy, search data, contract channel, chosen channel, contract channel available, and requested channels.

The user interface may include a search results table 600 for displaying available offers. In some cases, the search results table 600 may present offer details in a standardized format, regardless of the original data structure received from different supplier systems. This harmonized presentation may enable users to easily compare offers across multiple sources.

An offer details panel 610 may provide expanded information for a selected offer from the search results table 600. The offer details panel 610 may display specific attributes and terms associated with the selected offer, allowing users to review comprehensive information before making a booking decision.

The user interface may feature a selected offers section 620 containing offers that have passed through the rate filtering process and been validated as compliant with negotiated contract terms. In some cases, the selected offers section 620 may employ visual formatting to distinguish these approved offers, such as highlighting, or prominent positioning within the interface.

A dismissed offers section 630 may be included to manage offers that have been filtered out due to non-compliance with contract terms or duplicate detection. In some cases, the dismissed offers section 630 may be hidden from view entirely, presenting users with only valid, bookable options. This approach may streamline the user experience by focusing attention on compliant offers.

The interface may incorporate a search parameters panel 640 to display current search criteria and filtering options. Users may interact with the search parameters panel 640 to refine their search or adjust filtering preferences, triggering new requests to the rate filtering system.

A hotel data section 650 may present detailed information about hotel properties, including amenities, policies, and other relevant attributes used in the contract validation process. This information may help users make informed decisions based on both rate details and property characteristics.

In some cases, the rate filtering system may transmit the compiled list of compliant offers to the client computing device through a response module. The response module may format the offer data for optimal display within the user interface, ensuring consistent presentation across different device types and screen sizes.

The application on the client computing device may access the rate filtering system through various channels. In some cases, users may interact with the system via a web browser interface. Additionally, the system may support access through a native mobile application, providing platform-specific optimizations for smartphones, and tablets.

The user interface design may prioritize clarity and simplicity by hiding non-compliant rates entirely from users. Rather than displaying filtered options with visual indicators of their non-compliance, the interface may present only valid, bookable offers. This approach may create a harmonized information architecture that reduces cognitive load for users and streamlines the booking process.

By implementing these enhanced user interface and experience features, the rate filtering system may provide an intuitive and efficient platform for users to search, compare, and book travel offers while ensuring compliance with negotiated contract terms.

The rate filtering system may implement secure API connections to various supplier systems, including online travel agencies (OTAs), centralized reservation systems (CRS), and channel managers. These API connections may enable the system to retrieve hotel search results and bookable rate information from multiple sources in parallel.

In some cases, the system may utilize a secure communication module to establish encrypted data exchange channels with supplier systems. The secure communication module may implement virtual private network (VPN) or Secure Shell (SSH) tunneling protocols to ensure the confidentiality and integrity of data transmissions between the rate filtering system and external supplier APIs.

Before accepting offer data from a supplier system, the secure communication module may authenticate each supplier using digital certificates. This authentication process may help prevent unauthorized access and ensure that data is only exchanged with verified partner systems.

The rate filtering system may connect to hotel search endpoints provided by supplier APIs to retrieve lists of available properties matching user-specified search parameters. In some cases, these search parameters may be received from a client device over an encrypted channel, maintaining end-to-end security for user queries.

After obtaining search results, the system may query rate retrieval endpoints for each identified property. These queries may be executed in parallel across multiple supplier systems to minimize overall response time. The rate retrieval process may return detailed offer information, including pricing, room types, and rate conditions. In examples, during the query, examples may store memory flags in a cloud-based key-value store for tracking offer attribute comparisons and provide real-time alerts when a supplier systems fail to respond within a predefined timeout period.

The system may process proprietary rate data formats returned by different supplier APIs. In some cases, the rate filtering system may employ specialized parsers or data transformation modules to extract relevant offer attributes from varied response structures. This processing may enable uniform comparison and filtering of offers across diverse supplier systems.

Real-time rate filtering may be applied to the retrieved bookable rates. The filtering process may validate offer attributes against negotiated contract terms, check for blackout periods, and verify pricing accuracy. Non-compliant offers may be excluded from the final results set.

In some cases, the rate filtering system may provide an API for third-party travel management systems to access the compiled list of contract-compliant offers. This API may enable integration with external booking platforms while ensuring that only validated, compliant rates are made available for reservation.

The system may implement rate caching mechanisms to optimize performance when interacting with supplier APIs. Cached rate data may be used to generate initial search results quickly, while real-time filtering continues to be applied using the most current contract information.

To support system scalability, the rate filtering application may be deployed in containerized environments on cloud infrastructure. This architecture may allow for dynamic allocation of computing resources to handle varying levels of API traffic and processing load.

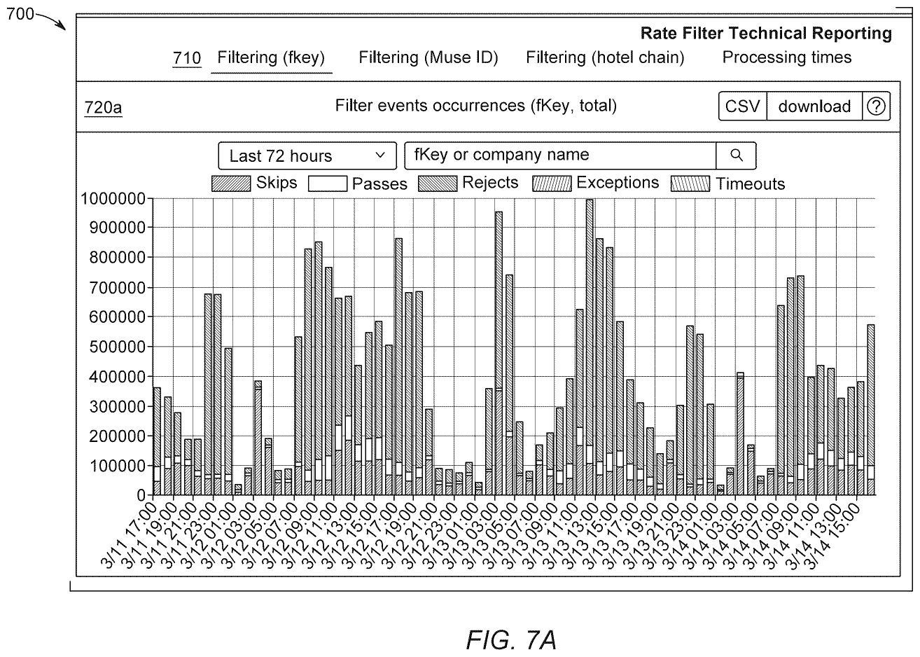

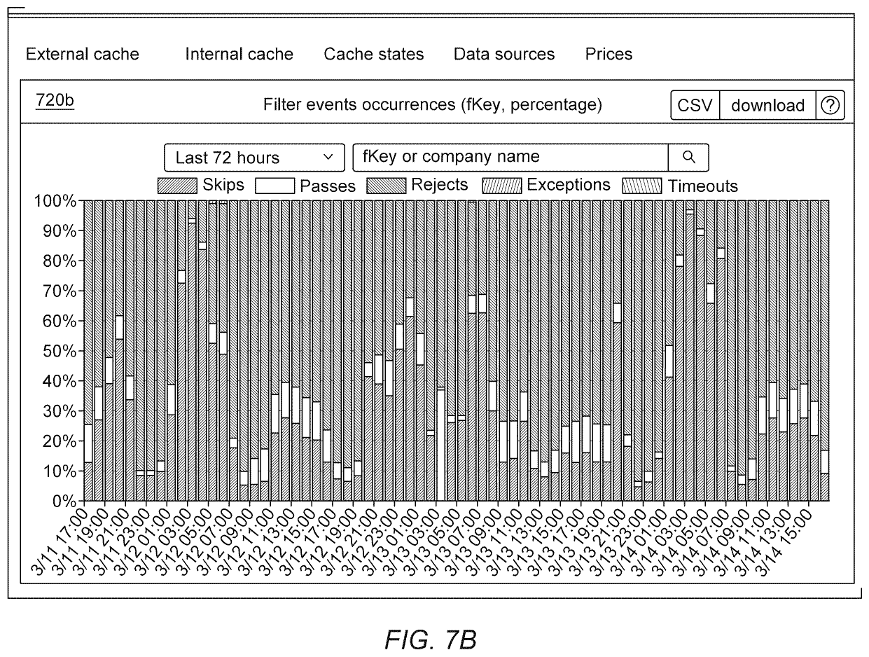

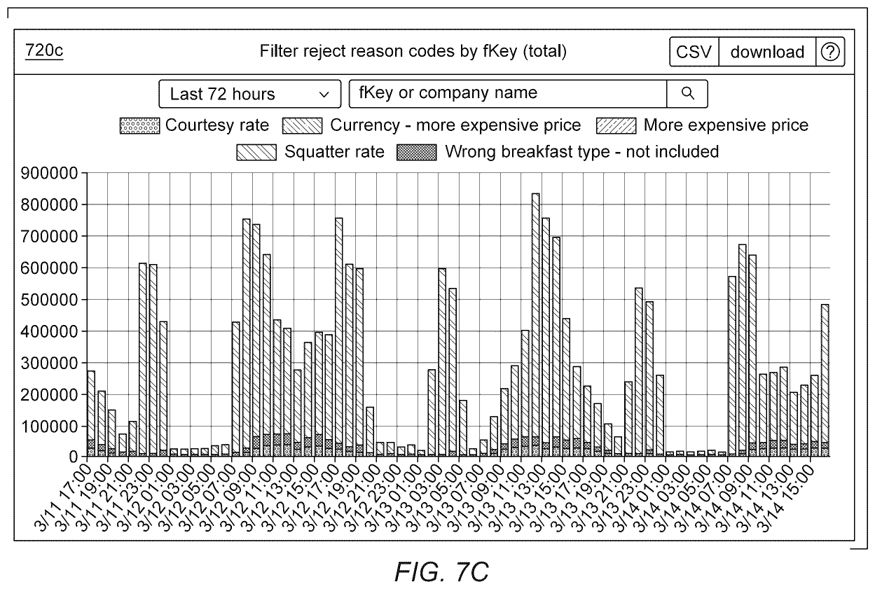

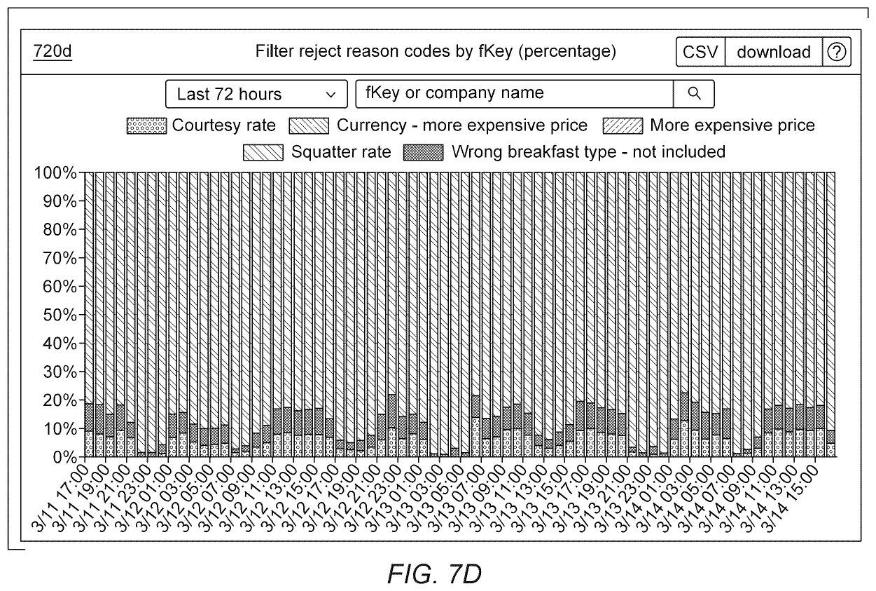

FIGS. 7A-D illustrate an example interactive dashboard 700 interfaces providing rate filter technical reporting, in accordance with aspects discussed herein. A series of selectable buttons 710 e.g., tabs, graphical buttons, drop-down menus, etc., provided on the dashboard may provide various data categories through which data may be provided textually, visually, graphically, or in any of a plurality of manners that can be customized by a user. The selectable button 710 categories may include filtering by a key/keyword, filtering by an identifier, filtering by a hotel chain, processing times, external cache, internal cache, cache states, and data sources.

In the illustrated examples, FIGS. 7A-7D provide several graphs 720a, 720b, 720c, and 720d, which illustrate filtered event occurrences, and compare the fKey (e.g., a designating identifier) over a period of time. FIG. 7A illustrates a graph filtering event occurrences, (fKey, total), FIG. 7B illustrates a graph filtering event occurrences (fKey, percentage), FIG. 7C illustrates a graph filtering reject reason codes by fKey (total), and FIG. 7D illustrates a graph filtering reject reason codes by fKey (percentage). The illustrated graphs can be customized to focus on particular category. For example the illustrated graphs show filtering by fKey compared to: filtered event occurrence (total) 720a, filtered event occurrences (percentage) 720b, filtered reject reason codes (total) 720c, and reject reason codes (percentage) 720d.

In various examples, the data may be connect to various supplier systems, including centralized reservation systems (CRS), online travel agencies (OTAs), and channel managers. In some cases, the output data may interface with specific CRS systems such as CRS systems for specific hotel chains, and output information in a particular format, such as XML.

To harmonize the varied structured and unstructured data formats, systems and methods may employ a multi-stage processing pipeline. In the first stage, raw data from each supplier system may be ingested through dedicated connectors tailored to each specific format. These connectors may handle authentication, data extraction, and initial format-specific parsing.

The second stage may involve data normalization, where the parsed information from different sources may be mapped to a standardized internal data model. This model may define common fields and data types for representing travel offers, accommodations, rates, and other relevant attributes across all connected systems.

In the third stage, the normalized data may undergo enrichment and validation. Information may be cross-referenced between different sources, fill in missing fields where possible, and perform consistency checks to ensure data quality.

The final stage of the pipeline may involve data indexing and storage. The harmonized and enriched data may be indexed for efficient querying and stored in a format optimized for rapid retrieval during subsequent filtering and offer comparison operations.

The rate filter 700 may then output information related to this harmonized dataset to perform contract validation, de-duplication, and other filtering operations as part of the overall offer processing workflow. By standardizing the diverse input formats into a consistent internal representation, the multi-source data harmonization architecture may enable uniform processing and comparison of travel offers across the wide range of connected supplier systems.

The rate filtering engine may utilize a cloud-based key-value store for storing memory flags during offer comparison and deduplication processes. The memory flag storage system may enable efficient tracking of offer attribute comparisons across distributed instances of the rate filtering engine.

In an embodiment, a system for real-time rate multi-sourcing and offer filtering, comprising: an application operating on a client computing device, the application configured to generate an interactive dashboard comprising a set of interactive selections to designate travel search parameters; a computing system in secure communication with the application, the computing system configured to at least: in response to a user selection of a first interactive selection, query, in parallel and in real-time, a plurality of supplier systems for travel offers that match the travel search parameters; for each identified travel offer, extract, from a respective supplier system associated with the offer, offer attributes, wherein the offer attributes comprise one or more of a supplier identifier, a product identifiers, a currency, a price, a cancellation policy, one or more amenities; access a cloud-based key-value store to generate, for each queried travel offer, a set of memory flags associated with the offer attributes, wherein a memory flag is a binary indicator stored within the cloud-based key-value store; perform real-time offer deduplication, to iteratively assess the set of memory flags associated with each identified travel offer and remove any duplicates from the queried travel offers; and update the interactive dashboard with a listing of matching travel offers, offer attributes, and a second interactive selection to initiate, upon selection, booking with the supplier system.

In an embodiment, wherein the computing system is in secure communication with the application through at least one of a Virtual Private Network (VPN) and a Secure Shell (SSH) tunnel.

In an embodiment, further comprising a dynamic currency conversion module that applies a tolerance threshold to account for real-time exchange rate fluctuations when comparing offer prices to contract prices.

In an embodiment, wherein the tolerance threshold is dynamically adjusted based on historical exchange rate volatility data for a specific currency pair being converted.

In an embodiment, wherein the computing system further comprises at least one of an online booking tool (OBT) computation system and a distribution system.

In an embodiment, wherein the computing system is further configured to detect and flag offers with missing or ambiguous product identifiers for manual review.

In an embodiment, wherein the computing system is configured to apply a specialized language model (SLM) for extracting offer rate information from unstructured source data formats.

In an embodiment, a method for real-time, contract-compliant travel offer filtering, comprising: generating, on a client device, an interactive dashboard comprising at set of interactive selections to designate travel search parameters; in response to a user selection of a first interactive selection, querying, in parallel and in real-time, a plurality of supplier systems for travel offers that match the travel search parameters; for each identified travel offer, extracting, from a respective supplier system associated with the travel offer, offer attributes, wherein the offer attributes comprise one or more of a supplier identifier, a product identifiers, a currency, a price, a cancellation policy, one or more amenities; accessing a cloud-based key-value store to generate, for each queried travel offer, a set of memory flags associated with the offer attributes, wherein a memory flag is a binary indicator stored within the cloud-based key-value store; performing real-time offer deduplication, to iteratively assess the set of memory flags associated with each identified travel offer and remove any duplicates from the queried travel offers; and updating the interactive dashboard with a listing of matching travel offers, offer attributes, and a second interactive selection to initiate, upon selection, booking with the supplier system.

In an embodiment, wherein a first travel search parameter relates to blackout dates and causes the querying to check for blackout periods and exclude offers identified by the plurality of supplier systems that fall within any identified blackout period.

In an embodiment, wherein the querying of supplier systems is performed using asynchronous, non-blocking network requests to minimize response latency.

In an embodiment, wherein the querying applies a specialized language model trained on historical travel offer data to extract offer attributes from unstructured source data formats.

In an embodiment, further comprising generating a third interactive selection, which when selected via the interactive dashboard, generates an interactive rate filter report.

In an embodiment, wherein querying comprises: iterating through a list of one or more offers; identifying negotiated and non-negotiated offers; validating an offer against negotiated rate contract data consisting of any of supplier identification, products identifications, blackout time period, offer amenities, currency, price, tax and cancellation policy; classifying some offers to be correct or incorrect; classifying some offer amenity to be correct or incorrect; and generating a listing of identified travel offers.

In an embodiment, wherein offers are classified incorrect when at least one of: an associated offer supplier is not contracted, when the travel offer is not contracted, when a contracted blackout period overlaps with an offer period, when a contracted price does not match an offer price, a contracted tax does not match an offer tax, or a cancellation policy doesn't match the contracted cancellation policy.

In an embodiment, a computer-implemented system for validating negotiated travel rates in real-time, comprising: a processor; and a memory comprising instructions, which when executed by the processor, causes the computer-implemented system to at least: generate, on a client device, an interactive dashboard comprising at set of interactive selections to designate travel search parameters; in response to a user selection of a first interactive selection, query, in parallel and in real-time, a plurality of supplier systems for travel offers that match the travel search parameters; for each identified travel offer, extract, from a respective supplier system associated with the travel offer, offer attributes, wherein the offer attributes comprise one or more of a supplier identifier, a product identifiers, a currency, a price, a cancellation policy, one or more amenities; access a cloud-based key-value store to generate, for each queried travel offer, a set of memory flags associated with the offer attributes, wherein a memory flag is a binary indicator stored within the cloud-based key-value store; perform real-time offer deduplication, to iteratively assess the set of memory flags associated with each identified travel offer and remove any duplicates from the queried travel offers; and update the interactive dashboard with a listing of matching travel offers, offer attributes, and a second interactive selection to initiate, upon selection, booking with the supplier system.

In an embodiment, wherein a first travel search parameter relates to blackout dates and causes the query to check for blackout periods and exclude offers identified by the plurality of supplier systems that fall within any identified blackout period.

In an embodiment, further comprising instructions which cause the computing system to generate a log comprising validation decisions with timestamps and reason codes for regulatory compliance auditing.

In an embodiment, wherein the query applies a specialized language model trained on historical travel offer data to extract offer attributes from unstructured source data formats.

In an embodiment, further comprising instructions which cause the computing system to generate a third interactive selection, which when selected via the interactive dashboard, generates an interactive rate filter report.

In an embodiment, a machine-implemented method of real-time rate multi-sourcing and rate filtering, the method comprising: extract, via a travel products aggregator, a supplier identifier and product identification data, in real-time, from different supplier offers received by different supplier systems, and associating rate attributes with the supplier identifier and product identification data; wherein the travel products aggregator comprises at least one distribution system configured to communicate, in real-time, with the different supplier systems over a plurality of networks, and book reservations at one, or more online booking tools (OBTs) associated with the different supplier systems; associate rate attributes with the supplier identifier and product identification data; receiving, at an Online Booking Tool (OBT) server, travel information input via an application operating on a client computing device; generating, at the OBT, an offer request for a travel product based on the travel information, wherein the travel product comprises a first set of rate attributes; generating, at the travel products aggregator, a set of supplier offers for the travel product based on the offer request; generating an updated set of supplier offers in real-time by applying an iterative comparison of memory flags associated with each supplier offer in the set of supplier offers, wherein the iterative comparison comprises: setting a first memory flag for a travel product property associated with a first supplier offer; setting a second memory flag for a travel product property associated with a second supplier offer; and deleting at least one of the first supplier offer and the second supplier offer when the first memory flag and the second memory flag are associated with a same travel product property; determining a set of negotiated rates, based on the updated set of supplier offers, corresponding to the travel product, the negotiated rates satisfying the first set of rate attributes; validating at least one negotiated rate; generating a set of validated offers based on the at least one validated negotiated rate; providing the set of validated offers to the application on the client computing device; based on a selection of a first validated offer at the client computing device, booking the travel product and the first validated offer through the first supplier system; and providing, at the application, booking information corresponding to the travel product.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

A number of implementations have been described. Nevertheless, it will be understood that various modifications may be made without departing from the spirit and scope of the disclosure. Accordingly, other implementations are within the scope of the following claims.

In some cases, the SLM may be trained specifically on historical travel offer data to process various proprietary data formats provided by different supplier systems. The SLM may extract structured rate components from unstructured text data that contains encoded travel product information.

The SLM may process data from global distribution systems (GDS) and other supplier systems that provide offer information in proprietary coding and formatting methods. In some cases, unstructured source data may include text strings containing multiple rate attributes encoded within a single field, such as advance purchase requirements, loyalty point eligibility, room descriptions, accessibility features, bathroom amenities, connectivity options, physical room characteristics, occupancy limits, and meal inclusion status. The SLM may parse such unstructured text to identify and extract individual rate components for comparison against contract terms.

The training methodology for the SLM may utilize historical user complaint data about duplicated rates to improve extraction accuracy. In some cases, the SLM may be trained on datasets where users or customers complained about duplicated rates, allowing the model to learn shared key attribute sets from pairs of rates that were identified as duplicates. The training process may enable the SLM to recognize common occurrences of terms used in originating source rate information and map such terms to standardized data model formats.

What is claimed:

1. A system for real-time rate multi-sourcing and offer filtering, comprising:
an application operating on a client computing device, the application configured to generate an interactive dashboard comprising a set of interactive selections to designate travel search parameters;
a computing system in secure communication with the application, the computing system configured to at least:
in response to a user selection of a first interactive selection, query, in parallel and in real-time, a plurality of supplier systems for travel offers that match the travel search parameters;
for each identified travel offer, extract, from a respective supplier system associated with the offer, offer attributes, wherein the offer attributes comprise one or more of a supplier identifier, a product identifiers, a currency, a price, a cancellation policy, one or more amenities;
access a cloud-based key-value store to generate, for each queried travel offer, a set of memory flags associated with the offer attributes, wherein a memory flag is a binary indicator stored within the cloud-based key-value store;
perform real-time offer deduplication, to iteratively assess the set of memory flags associated with each identified travel offer and remove any duplicates from the queried travel offers; and
update the interactive dashboard with a listing of matching travel offers, offer attributes, and a second interactive selection to initiate, upon selection, booking with the supplier system.

2. The system of claim 1, wherein the computing system is in secure communication with the application through at least one of a Virtual Private Network (VPN) and a Secure Shell (SSH) tunnel.

3. The system of claim 1, further comprising a dynamic currency conversion module that applies a tolerance threshold to account for real-time exchange rate fluctuations when comparing offer prices to contract prices.

4. The system of claim 3, wherein the tolerance threshold is dynamically adjusted based on historical exchange rate volatility data for a specific currency pair being converted.

5. The system of claim 1, wherein the computing system further comprises at least one of an online booking tool (OBT) computation system and a distribution system.

6. The system of claim 1, wherein the computing system is further configured to detect and flag offers with missing or ambiguous product identifiers for manual review.

7. The system of claim 1, wherein the computing system is configured to apply a specialized language model (SLM) for extracting offer rate information from unstructured source data formats.

8. A method for real-time, contract-compliant travel offer filtering, comprising:
generating, on a client device, an interactive dashboard comprising at set of interactive selections to designate travel search parameters;
in response to a user selection of a first interactive selection, querying, in parallel and in real-time, a plurality of supplier systems for travel offers that match the travel search parameters;
for each identified travel offer, extracting, from a respective supplier system associated with the travel offer, offer attributes, wherein the offer attributes comprise one or more of a supplier identifier, a product identifiers, a currency, a price, a cancellation policy, one or more amenities;
accessing a cloud-based key-value store to generate, for each queried travel offer, a set of memory flags associated with the offer attributes, wherein a memory flag is a binary indicator stored within the cloud-based key-value store;
performing real-time offer deduplication, to iteratively assess the set of memory flags associated with each identified travel offer and remove any duplicates from the queried travel offers; and
updating the interactive dashboard with a listing of matching travel offers, offer attributes, and a second interactive selection to initiate, upon selection, booking with the supplier system.

9. The method of claim 8, wherein a first travel search parameter relates to blackout dates and causes the querying to check for blackout periods and exclude offers identified by the plurality of supplier systems that fall within any identified blackout period.

10. The method of claim 8, wherein the querying of supplier systems is performed using asynchronous, non-blocking network requests to minimize response latency.

11. The method of claim 8, wherein the querying applies a specialized language model trained on historical travel offer data to extract offer attributes from unstructured source data formats.

12. The method of claim 8, further comprising generating a third interactive selection, which when selected via the interactive dashboard, generates an interactive rate filter report.

13. The method of claim 8, wherein querying comprises:
iterating through a list of one or more offers;
identifying negotiated and non-negotiated offers;
validating an offer against negotiated rate contract data consisting of any of supplier identification, products identifications, blackout time period, offer amenities, currency, price, tax and cancellation policy;
classifying some offers to be correct or incorrect;
classifying some offer amenity to be correct or incorrect; and
generating a listing of identified travel offers.

14. The method of claim 13, wherein offers are classified incorrect when at least one of: an associated offer supplier is not contracted, when the travel offer is not contracted, when a contracted blackout period overlaps with an offer period, when a contracted price does not match an offer price, a contracted tax does not match an offer tax, or a cancellation policy doesn't match the contracted cancellation policy.

15. A computer-implemented system for validating negotiated travel rates in real-time, comprising:
a processor; and
a memory comprising instructions, which when executed by the processor, causes the computer-implemented system to at least:
generate, on a client device, an interactive dashboard comprising at set of interactive selections to designate travel search parameters;
in response to a user selection of a first interactive selection, query, in parallel and in real-time, a plurality of supplier systems for travel offers that match the travel search parameters;
for each identified travel offer, extract from a respective supplier system associated with the travel offer, offer attributes, wherein the offer attributes comprise one or more of a supplier identifier, a product identifiers, a currency, a price, a cancellation policy, one or more amenities;
access a cloud-based key-value store to generate, for each queried travel offer, a set of memory flags associated with the offer attributes, wherein a memory flag is a binary indicator stored within the cloud-based key-value store;
perform real-time offer deduplication, to iteratively assess the set of memory flags associated with each identified travel offer and remove any duplicates from the queried travel offers; and
update the interactive dashboard with a listing of matching travel offers, offer attributes, and a second interactive selection to initiate, upon selection, booking with the supplier system.

16. The computer-implemented system of claim 15, wherein a first travel search parameter relates to blackout dates and causes the query to check for blackout periods and exclude offers identified by the plurality of supplier systems that fall within any identified blackout period.

17. The computer-implemented system of claim 15, further comprising instructions which cause the computing system to generate a log comprising validation decisions with timestamps and reason codes for regulatory compliance auditing.

18. The computer-implemented system of claim 15, wherein the query applies a specialized language model trained on historical travel offer data to extract offer attributes from unstructured source data formats.

19. The computer-implemented system of claim 15, further comprising instructions which cause the computing system to generate a third interactive selection, which when selected via the interactive dashboard, generates an interactive rate filter report.
